(19) United States
(12) Patent Application Publication
(10) Pub. No.: US 2011/0100358 A1
(43) Pub. Date: May 5, 2011

(54) Low Cost Fixed Focal Point Parabolic Trough

(76) Inventor: Randal Jerome Perisho, Conway, MO (US)

(21) Appl. No.: 12/874,215

(22) Filed: Sep. 1, 2010

Related U.S. Application Data
(60) Provisional application No. 61/275,885, filed on Sep. 4, 2009.

(51) Int. Cl. F24J 2/12; F16H 19/08

(52) U.S. Cl. 126/690; 74/37

(57) ABSTRACT

In accordance with one embodiment, a parabolic trough system is disclosed to capture solar heat. It has low mass, high rigidity and precise robust rotational control. The trough does not require massive supports, since it use a “sandwich structure” where the core is lightweight urethane foam and the skin is made of aluminum sheet. The inside skin also functions as the parabolic reflector. The shape minimizes wind loads by centering the receiver in the parabola and by making the center of focus the center of rotation.

The system can be rapidly built in the field since there are few parts. Assembly does not require heavy equipment. Support posts are used on both sides of the trough to minimize the anchoring requirements in wind loads.

The trough bodies are rotated in a rotational control mechanism that uses circumscribing rings to support a continuous row of troughs that can sustain 120 mile per hour winds. Optical performance is improved with the drive ring design. The structure is continuous and torque is uniformly applied to each ring through two spools supported on drive tubes. A cable is wrapped around each spool as well as around the top part of the ring. As the spools rotate, they pull the cable and rotate the rings and troughs with precision and strength. The spools and cables also restrain the system under high wind loads.

### CROSS-REFERENCE TO RELATED APPLICATIONS

application Ser. No. 12/874,215 Filed Sep. 1, 2010

Provisional Application 61/275,855 Filed Sep. 4, 2009

### OTHER PUBLICATIONS

Parabolic-Trough Technology Roadmap: A Pathway for Sustained Commercial Development and Deployment of Parabolic-Trough Technology, January 1999 by Hank Price (National Renewable Energy Lab), and David Kearney (Kearney and Associates) Report No. NREL/TP-550-24748

Sandwich Construction Solar Structural Facets Jan. 21, 1999, by Richard B Diver and James Grossman of Sandia National Laboratories Albuquerque, N. Mex. 87185

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to parabolic troughs for concentrating solar energy along an axis, specifically a system of low cost parabolic troughs that can sustain high wind loads.

2. Prior Art

Previously parabolic troughs have been limited in torsion strength and as a result this impacts initial cost, optical accuracy, and maintenance costs. A parabolic trough is typically composed of a body or support structure that supports a parabolic reflective element. A tracking system is employed to rotate the trough to keep it normal to light from the sun. The parabolic shape brings focus along an axis where a receiver pipe is heated and in turn liquid circulating inside the receiver is heated and conveyed to the point of use. The receiver is typically black in color for high absorption and covered with a glass tube to minimize convection heat loss. The support structure for the reflector must be rigid enough to accommodate wind loads that deform and twist the structure during normal operation. Normal wind loads will deform the parabolic shape and affect how light reaches the focal point. Inefficiencies occur when the light misses the receiver because of excess deformation. The parabolic shape and tracking is critical for this type of device. The reflected light only has a zone of 1 to 3 degrees wide where the light must hit some part of the receiver. If one end of the trough twists three degrees, the reflected light at this end will totally miss the receiver and render the device useless. The trough must be accurately formed, rigid in structure and employ a precise tracking system in order to capture all the solar energy available.

Troughs must also be designed to sustain high wind loads. The air pressure applied to a trough is similar to what a kite experiences. There is a massive area facing the wind and the developed loads must not permanently deform the reflective surface or support structure. Current technology typically sustains 80 mile per hour Class 1 wind loads of 25 pounds per square foot, but not 120 mile per hour gusts of 45 pounds per square foot as seen in coastal areas.

Some parabolic trough designs employ a sheet of glass or plastic over the open end of the trough to minimize heat loss and provide enhanced strength to resist high wind loads. U.S. Pat. Nos. 4,153,039 by Carroll (1979) and 4,108,154 by Nelson (1978) show a sheet of clear plastic or glass to protect the reflector. The extra material adds cost and limits the size of trough that can be built with this method. These troughs are typically less than ten feet long.

Longer troughs can be formed if the support structure is rotated with a large drive tube. U.S. Pat. No. 5,069,540 by Gonder (1991) and U.S. Pat. No. 4,135,493 by Kennedy (1979) show a large drive tube on the lower portion of the trough to provide enhanced torsion strength. These designs are costly due to the complex weld joints used to join the parabolic ribs to the main torque tube. The torque tube carries a large induced torque just to rotate the trough. All of the weight of the trough is on one side in reference to the center of rotation. The trough is only balanced at noon when the trough is directly above the torque tube. During most of the day, the drive and brake system must sustain a huge torque load from the weight of the trough being held in one position. The drive and brake loads are magnified with the effect of wind and as a result these systems typically employ expensive hydraulic drives to hold and drive trough position. One approach to help with the offset loading is to use counterweights for balance, but it still does not help with unbalanced wind loads which often exceed the weight of the structure.

The largest trough systems are open to environmental conditions. The reflective materials have been developed to sustain environmental exposure for ten years or more and extensively tested by the National Renewable Energy Lab (NREL). These large troughs are supported by struts at each end of the trough. Wind loads induce huge reaction loads at these support struts and they require massive concrete anchors to hold the system in position. The overall system cost is reduced by maximizing the area focused on a single receiver tube. U.S. Pat. Nos. 4,287,003 (1991), 4,372,651 (1983) by Hutchison show troughs 6 meters long by 2.5 meters wide that experience up to 4035 pounds force from 80 mile per hour wind loads. The corresponding anchor system is very expensive when supporting these large troughs. Six feet tall struts induce 24,000-foot-lbs of torque at the base of each strut and require a concrete anchor 10 feet in diameter and 8 feet deep with standard soil reaction pressures of 150 pounds per square foot. Other U.S. patents using V-shaped support struts are U.S. Pat. Nos. 4,454,371 by Faolin (1984); 4,515,148 by Boy-Marcotte et al. (1985); 4,528,977 by Malley (1985); and 5,964,216 by Hoffschmidt et al. (1999). Each trough requires its own drive and brake system to track the sun because struts are placed between each trough. If one drive fails or is not synchronous, it fractures the receiver pipe and leads to very high maintenance costs. High cost of receiver breakage was a weakness discovered in the early SEGGS plants described by Price and Kearney in Parabolic-Trough Technology Roadmap: A Pathway for Sustained Commercial Development and Deployment of Parabolic-Trough Technology.

The drive and brake devices are normally at one end of the trough. Since wind loads and gravity apply to the entire trough, there is a twisting moment across the face of each trough that causes optical error particularly at medium wind speeds of 15 to 30 miles per hour. The most publicized SEGGS trough system in Daggett Calif. experiences high maintenance costs from this type of loading. The glass reflectors are fragile and fracture when the trough structure is deformed from wind loads. To minimize torque related deformation, U.S. Pat. No. 5,058,565 by Gee et al. (1991) uses cross braces for lateral support on each trough. The patent also describes alternative reflective materials such as mirrored polymer film or polished metal to avoid fractured glass. The sheet material in the above patents does not clarify detail about how the reflective material is supported and is thus prone to have permanent deformation at high wind loads.

Conventional large troughs use a strut at each end for support. In addition, they employ one actuator per trough to rotate the trough. When a row of troughs is used for a large system, every trough must operate in unison because they all connect to a common receiver that carries the hot liquid. If one trough is misaligned or the actuator fails, when the other units rotate, the receiver typically fractures and causes high heat losses and will sometimes start leaking forcing a shut-down of the entire system for repair. Most conventional systems experience high maintenance costs because of receiver tube breakage and leakage as referenced by the SEGGS plant report by Price and Kearney (referenced previously).

Several new patents are based on using thin reflective material rather than glass mirrors in order to reduce cost. Glass mirrors on troughs are very expensive as they must be formed to very precise parabolic geometry and they are also very fragile. A new material “ReflecTech Film” (reflectechsolar.com) has proven to survive 10 year life tests in the desert and is available at substantially lower entry costs. A material like this is put in tension to form the parabolic shape on U.S. Pat. No. 4,173,397 by Simpson (1979). In this patent, it only operates under a protective structure and this limits its use. U.S. Pat. No. 6,994,082 by Hutchberg et al. (2006) shows another configuration that must be placed inside of an inflated plastic housing to operate. The inflated housing is at risk from 80 mile per hour winds and from ultraviolet ray damage by the sun. Two U.S. patents, US 2007/0240704 A1 (2006) by Hochberg et al. and US 2008/0308094 (2008) by Johnson, are under patent application and both describe reflective polymer film stretched between ribs but without reference to how the film sustains high wind loads without damage from flutter and lack of support.

Concentrating troughs must accurately track the sun so the reflected light can focus on the receiver tube. Precise control is critical for high thermal efficiency. To briefly explain the importance, consider a trough that is 100 inches wide with a two inch diameter receiver in the center. A ray of light can travel approximately 50 inches after contacting the reflective material and must hit the one inch wide receiver. The total angle formed is the arctangent (2/50) or 0.04 radians. This is equal to 0.04 radians×180 degrees per 3.14 radians or 2.3 degrees width. Since the sun itself is about 0.5 degrees wide, there is only 1.8 degrees of motion left for error. This error is the combined effect of tracking error, optical reflective error on the trough, wind deformation error, and the angular zone needed as the trough is stationary and tracking for a short segment of time. State of the art tracking systems target rotational control to +/−0.1 degrees.

Methods of controlling rotation of the trough are hydraulic actuators, gear-motor drives with gears, chains or screw drives. Hydraulic units are ideal for large systems because they have high power and excellent precision, but they are costly. Gear motor drives relying on gears or screw drives can be accurate but suffer as they do not have much power. In that regard, high wind loads put a great deal of stress on spur gear or screw drive teeth. Typically, the gear connected to the trough is large for improved accuracy, but being large also makes them very expensive like the ones shown on U.S. Pat. Nos. 257,560 by Ditzler (1882); 4,077,392 by Garner (1978); 4,515,148 by Boy-Marcotte et al. (1985) and 4,559,926 by Butler (1985). Each tooth must be precisely machined or cast to shape and gets high contact stress in application as all the loads react through these teeth. This makes the teeth prone to high wear and deformation if they are overloaded.

When the trough is small, sometimes small gears are used to rotate the trough as shown in U.S. Pat. No. 4,011,858 by Hurkett (1977) or U.S. Pat. No. 4,245,616 by Wyland (1981). Since the troughs are small, loading on the teeth is not an issue, but precise rotational control is a concern. Very few gear-motors have the resolution required to rotate 1/10 of a degree accurately. Since there are 360 degrees in one revolution, the motor could only turn 1/3600 of a revolution. This implies that a 3600 ratio would be needed for the gearbox if the motor was controlled with a single output pulse per revolution. This mandates the use of stepper or synchronous motors that are again more costly particularly when they must be designed for outdoor conditions.

It should be noted that some troughs designs have the advantage of a fixed focal point. The receiver does not move, rather, the trough rotates around the receiver. A fixed focal point is a big advantage because the plumbing (receiver) never moves. A receiver that moves requires a specialized flex hose to allow for rotation and translation. They are known to have leakage issues and cause high maintenance costs. U.S. Pat. No. 4,454,371 by Folino (1984) and US patent application US 2006/0150967 A1 show troughs rotated with large circumscribing gears. Although they will have good rotational control with a large gear ratio between the drive and driven gears, they have not shown any provision to connect to the receiver. Since the receiver is not designed to be in the center of rotation, it will rotate and translate and be very difficult to connect to a working plumbing system. The associated hardware will be specialized, expensive, and difficult to maintain under the extreme operating temperatures and outdoor environmental conditions.

Rather than using a gear to rotate the trough, some designs employ a flexible member, such as a rope, a cable, a strap or a chain. These have the advantage of eliminating a large gear connected to the trough and thus reduce costs substantially. U.S. Pat. No. 1,162,505 by Nichols (1913) shows a system operated by hand or a mechanical clocking mechanism. The trough can be rotated in one direction but lacks sufficient detail to describe how the trough is moved back to the original position. U.S. Patent application US 2009/0183731 A1 shows a support circle with the parabolic reflector inside. This allows a unitary structure that can move as a whole and thus improve torsion strength. The drive system on this patent is not clearly described other than using a gear-motor.

U.S. Patent application US 2010/0018520 also shows a fixed focal point with the trough rotating about the receiver. The design is similar to a torque tube in that most of the trough weight is above the center of rotation and as a result, the drive and brake mechanisms must be robust, particularly if they are to sustain high wind loads. This particular system employs a support post driven into the ground with guy wires between each trough. As discussed earlier, the wind loads on a trough are enormous and unless concrete piers are employed, the system can not sustain typical 80 mile per hour winds.

A couple systems have been described as being able to concurrently rotate a row of troughs by using cable wrapped around a reference pipe under the troughs. U.S. Pat. No. 4,469,938 and U.S. patent application US 2010/0018520 show individual troughs supported by struts at each end of the trough. Passing through the bottom of the strut is a pipe that is used to control rotation of the trough. Both patents show a wire or cable wrapped around the pipe and with one end attached to the right side of the trough and the other end of the cable attached to the left side of the trough. As the pipe is rotated, it does provide additional leverage to rotationally control the trough. These troughs must sustain high torque under wind loads and steel cable could slip on the drive pipe with the designs shown. The patents do not show any anchoring means from the cable to the drive pipe.

A further advantage of current troughs is the ability to invert to protect the reflective surfaces during a storm or hail. Several trough systems have employed cables to link every row together and rotate them with a single actuator. U.S. Pat. No. 4,559,926 by Butler (1985) is a good example of this method. A cable is wrapped serpentine fashion to every row of troughs and as it moves it rotates each row concurrently. As the system is described, it relies on friction between the cable and circumscribing ring to rotate the trough. There is concern that as cables stretch over time, some troughs will slip and not track the sun properly. A similar concern is the necessity of selecting a cable strong enough to hold the combined torque of the entire system under wind loads, but also be flexible enough to wrap around the small support pulleys.

### SUMMARY

In accordance with one embodiment, a parabolic trough system is disclosed to capture solar heat. It has low mass, high rigidity and precise robust rotational control. The trough does not require massive supports, since it use a “sandwich structure” where the core is lightweight urethane foam and the skin is made of aluminum sheet. The inside skin also functions as the parabolic reflector. The shape minimizes wind loads by centering the receiver in the parabola and by making the center of focus the center of rotation.

The system can be rapidly built in the field since there are few parts. Assembly does not require heavy equipment. Support posts are used on both sides of the trough to minimize the anchoring requirements in wind loads.

The trough bodies are rotated in a rotational control mechanism that uses circumscribing rings to support a continuous row of troughs that can sustain 120 mile per hour winds. Optical performance is improved with the drive ring design. The structure is continuous and torque is uniformly applied to each ring through two spools supported on drive tubes. A cable is wrapped around each spool as well as around the top part of the ring. As the spools rotate, they pull the cable and rotate the rings and troughs with precision and strength. The spools and cables also restrain the system under high wind loads.

### DRAWINGS

### Figures

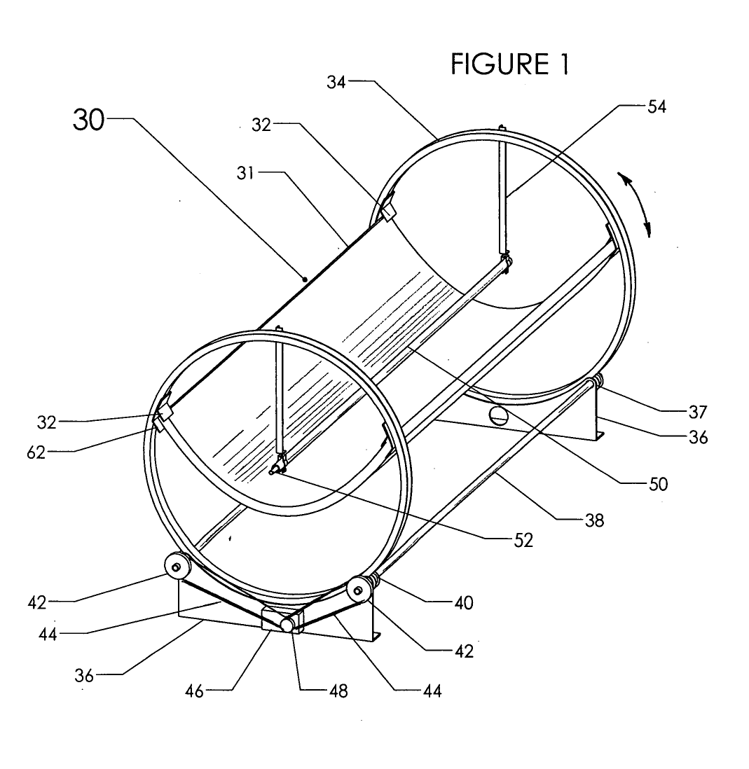

FIG. 1 is a perspective view of one embodiment of the fixed focal point trough assembly

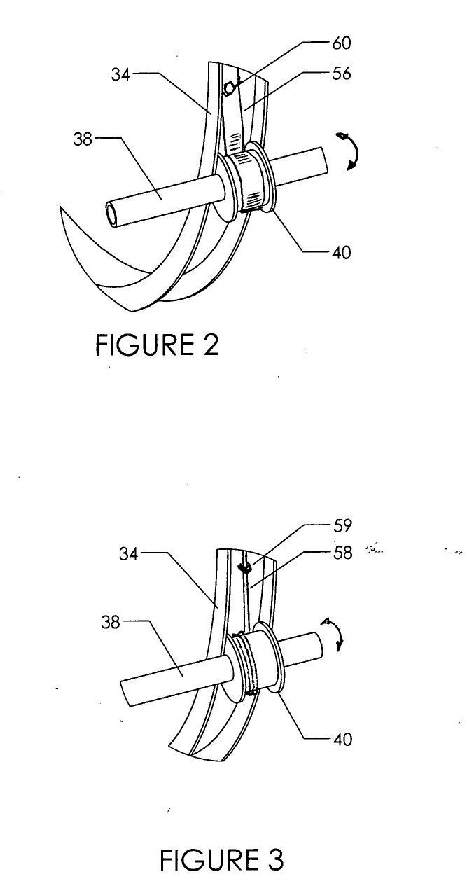

FIG. 2 is a close-up view of a spool with strap

FIG. 3 is a close-up view of a spool with wire rope or cable

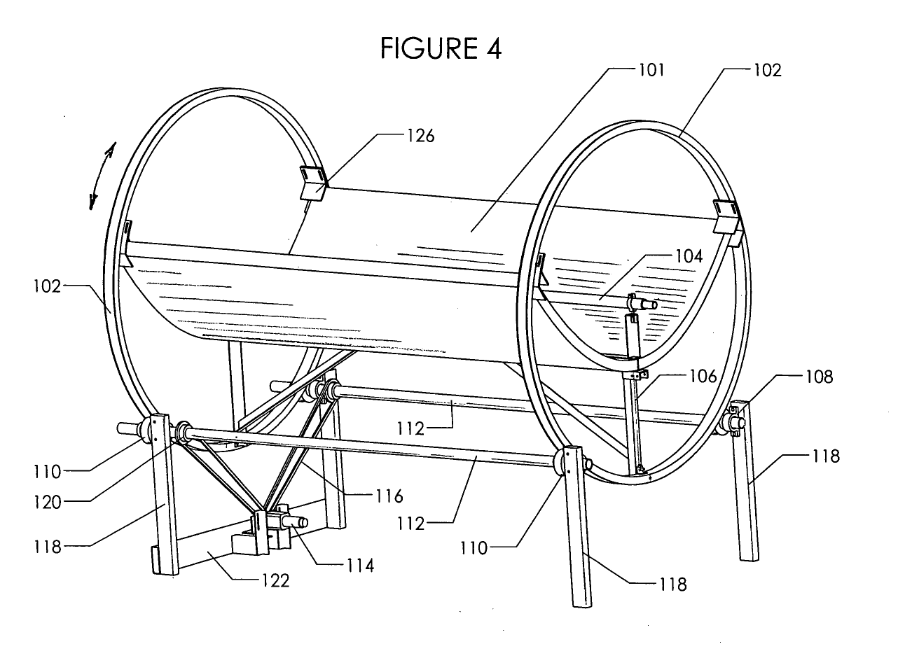

FIG. 4 is a perspective view of a second embodiment of a larger fixed focal point trough assembly

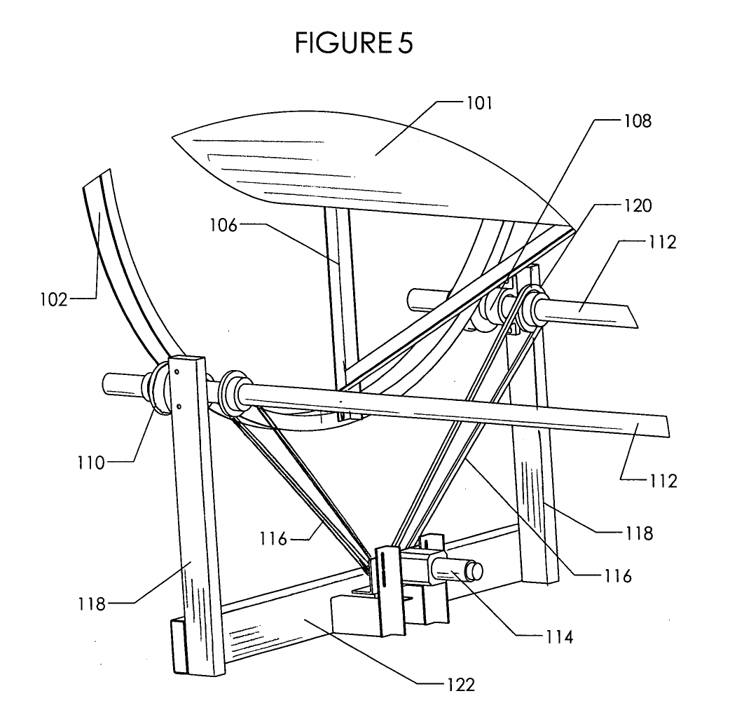

FIG. 5 is a close-up view of the drive system for the second embodiment

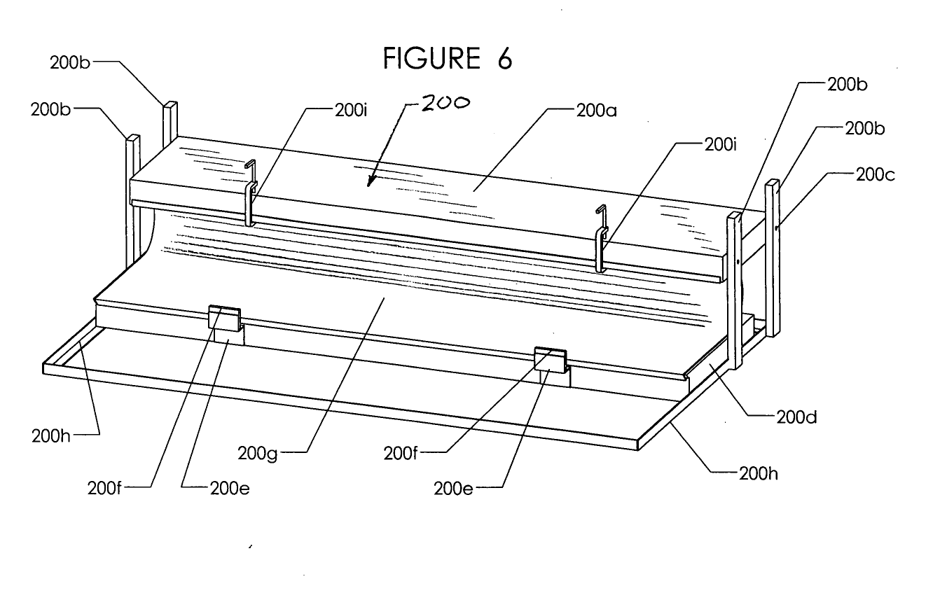

FIG. 6 is a perspective view of the rolling table assembly

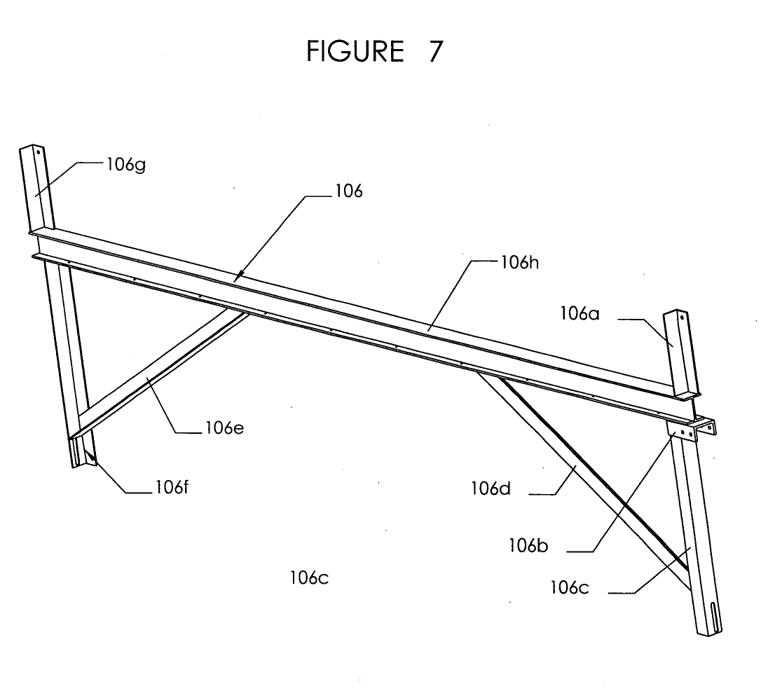

FIG. 7 is a perspective view of the I-beam assembly used in the second embodiment

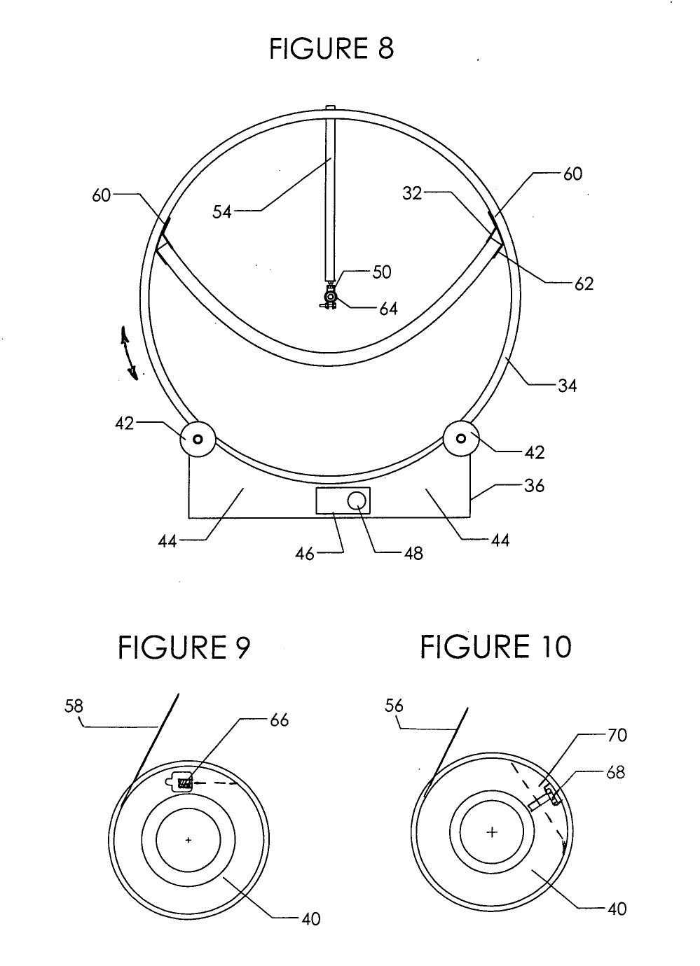

FIG. 8 is an end view of the first embodiment of a fixed focal point trough

FIG. 9 shows how a spool assembly is wound with a cable termination.

FIG. 10 shows how a spool assembly is wound with a strap termination.

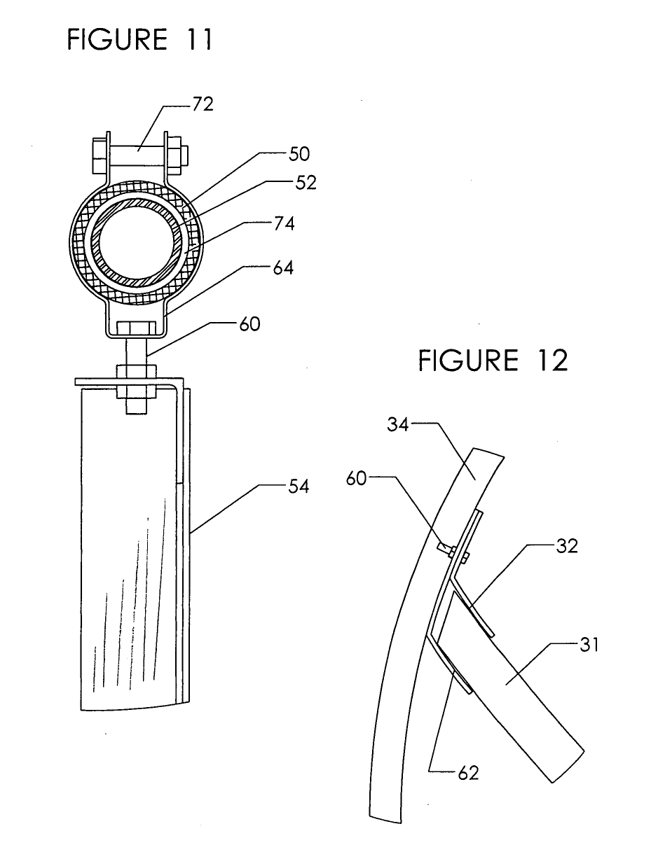

FIG. 11 shows a front view of the receiver assembly at the focal point of the reflective surface of the trough

FIG. 12 shows a how the trough body is held to the ring with tabs and bolts.

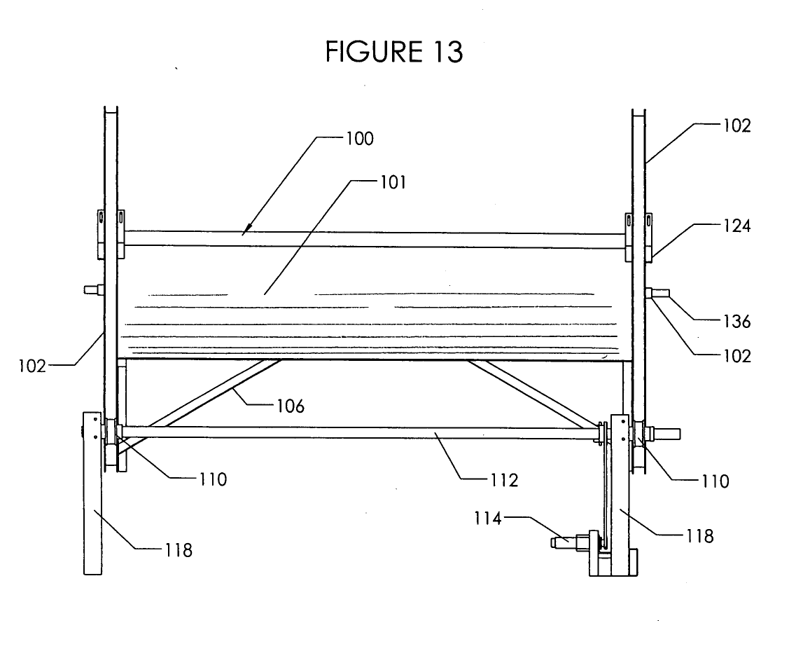

FIG. 13 shows a side view of the second embodiment

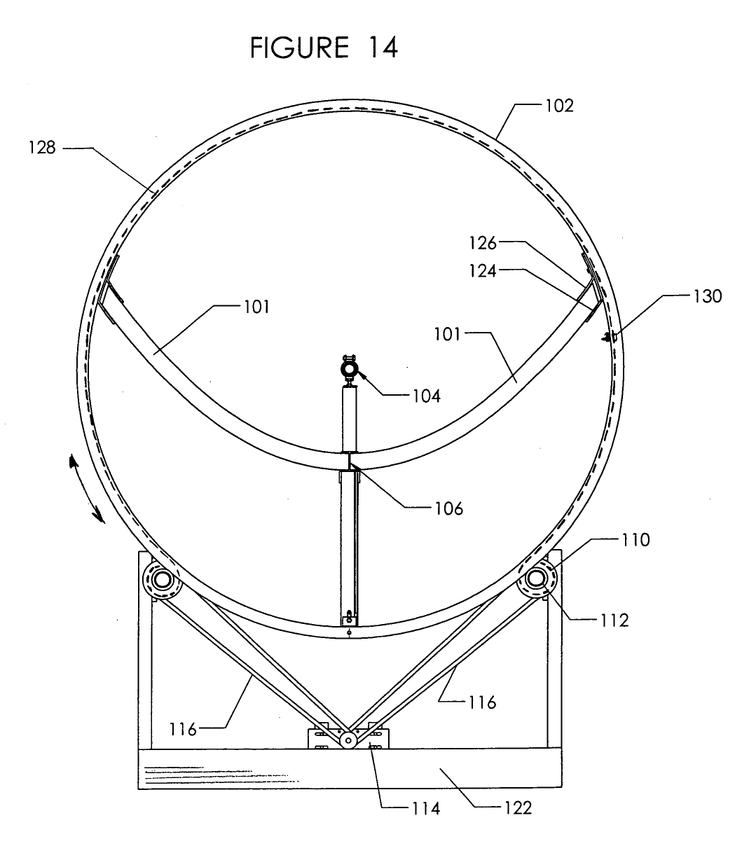

FIG. 14 is a front view of the second embodiment showing how two trough bodies are mounted to the I-beam assembly

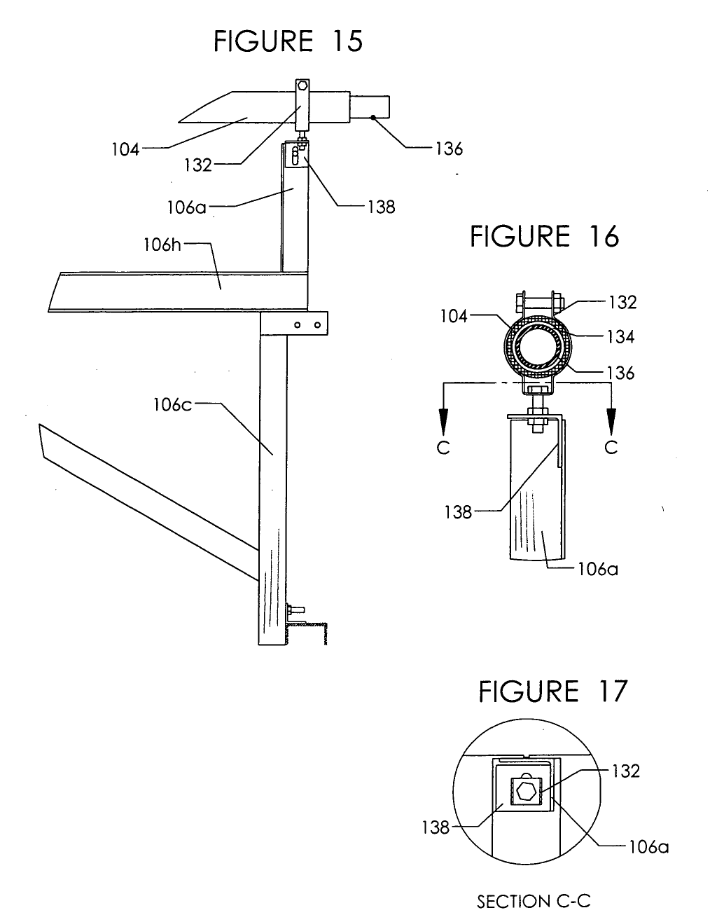

FIG. 15 is a close-up side view of the I-beam assembly as connected to the large ring and the glass pipe for the receiver.

FIG. 16 is section BB from FIG. 15 and clarifies how the pipe strap can be adjusted in height.

FIG. 17 is section CC from FIG. 16 and shows how the pipe strap can be adjusted sideways.

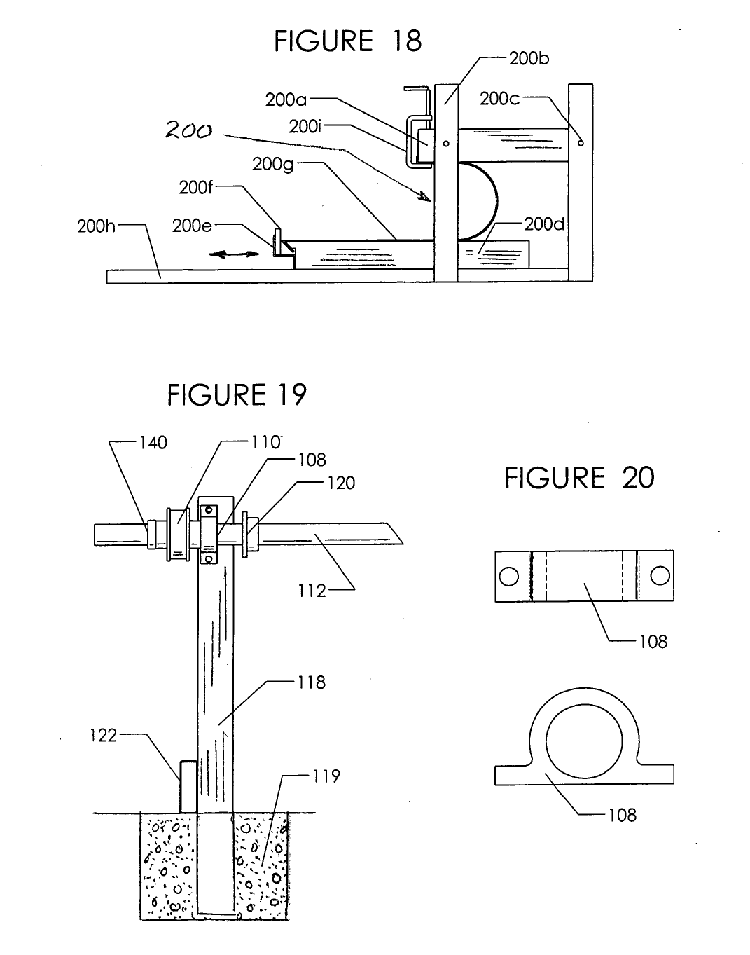

FIG. 18 is a side view of the Roller Table Assembly with aluminum sheet being rolled into shape.

FIG. 19 is a side view of a typical support post mounted in the ground with concrete.

FIG. 20 shows front and side views of the pillow block supporting the torque tube.

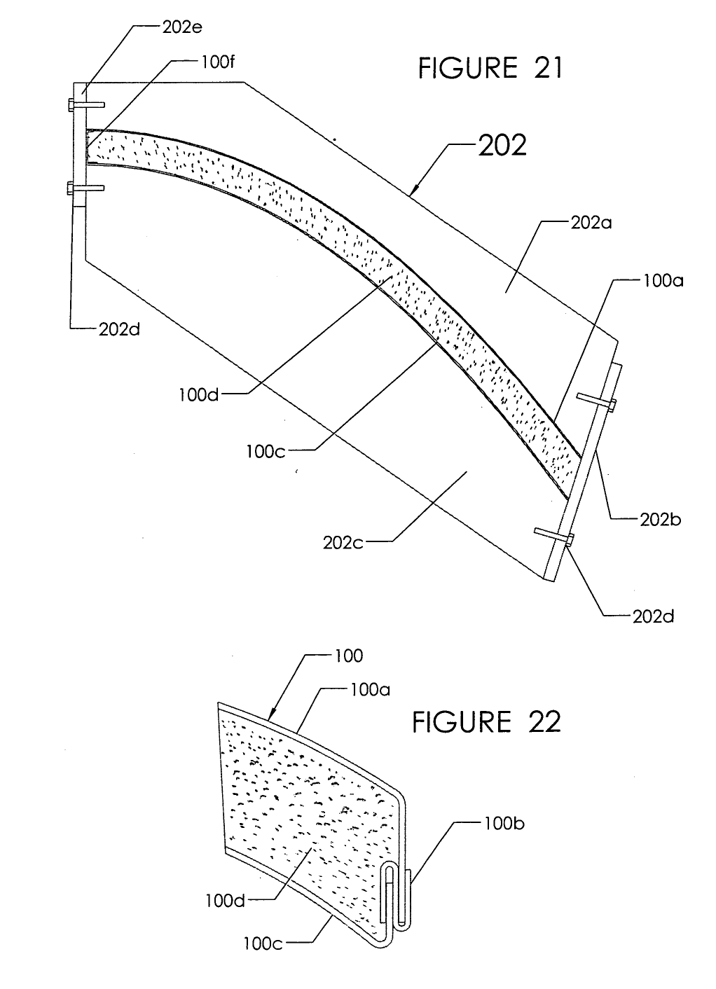

FIG. 21 shows an end view of the mold used to make the large fixed focal point trough bodies used in the second embodiment.

FIG. 22 shows a close up cross section of a trough body and how the front (reflector) and back aluminum sheets are joined with urethane foam.

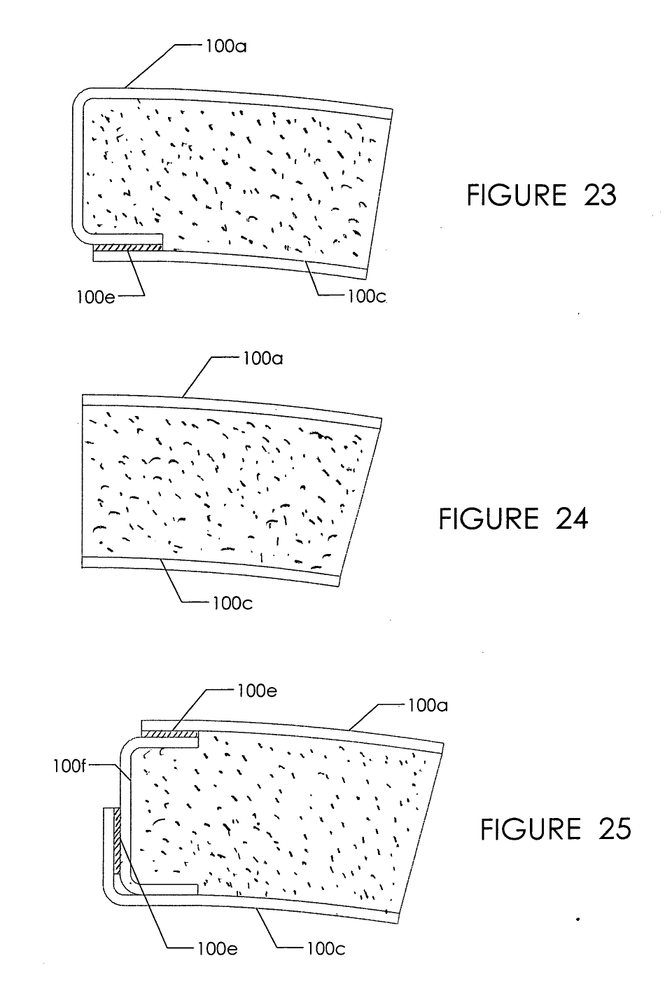

FIG. 23 shows one option for molding a trough body with the back sheet also forming the edge.

FIG. 24 shows an option for making an trough body with the foam exposed.

FIG. 25 shows an option for molding the edge of the trough body with another sheet of aluminum bent into a channel shape and adhered with two sided adhesive tape

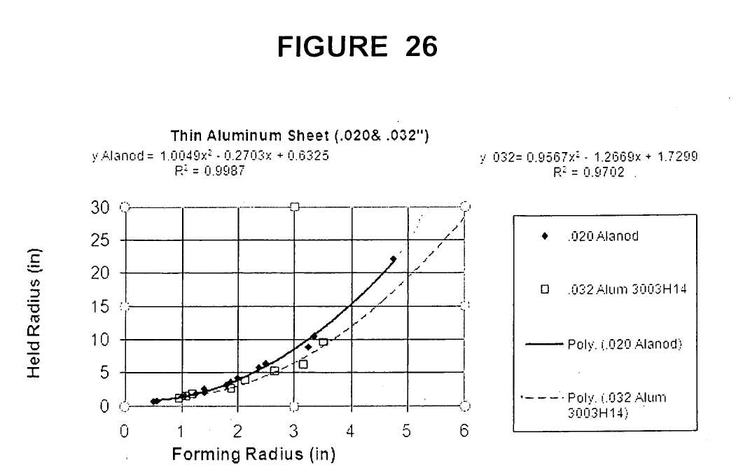

FIG. 26 is a graph showing the forming radius versus the held radius when rolling thin aluminum reflector (0.020 inch Alanod) or 0.032 inch 3003-H14 aluminum sheet stock.

### REFERENCE NUMERALS

30 Trough Assembly
31 Trough Body
32 Upper Tab
34 Ring
36 Base
37 Bushing
38 Torque Tube
40 Spool
42 Sprocket
44 Chain
46 Gear-motor
48 Dual Sprocket
50 Glass Pipe
52 Receiver
54 Upper Support
56 Strap
58 Cable
59 U-bolt
60 ⅜″ Bolt & Nut
62 Lower Tab
64 Pipe Strap
66 Cable Slug
68 Strap Bolt
70 Cap
72 ¼″ Bolt & Nut
74 PTFE Spacer
100 Large Trough Assembly
100a Bottom sheet
100b Z Strip
100c Aluminum reflector
100d Urethane foam
100e 2-sided tape
100f Aluminum channel
101 Large trough Body
102 Large Ring
104 Large Glass Pipe
106 I-Beam Assembly
106a I-Beam Vertical Support Right
106b I-Beam Pad
106c I-Beam Lower Support Right
106d I-Beam Angle Brace Right
106e I-Beam Angle Brace Left
106f I-Beam Lower Support Left
106g I-Beam Vertical Support Left
108 Pillow Block
110 Large Spool
112 Large Torque Tube
114 Large Gear-motor
116 Large chain
118 Post
119 Concrete
120 Large Sprocket
122 Horizontal Brace
124 Large Lower Tab
126 Large Upper Tab
128 Large Cable
130 U Bolt Assembly
132 Large Pipe Clamp
134 Large PTFE spacer
136 Large Receiver
138 Strap Support
140 Collar
200 Rolling Table Assembly
200a Top Table
200b Vertical Support
200c Pivot Pin
200d Lower Slide
200e Bent Stop
200f spacer
200g Aluminum sheet
200h Rails
200i clamp
202 Mold Assembly
202a Top Cavity
202b Right Plate
202c Bottom Cavity
202d Bolt
202e Left Plate

### DETAILED DESCRIPTION

### First Embodiment—FIG. 1

By referring to the drawings, the details and advantages of the present invention will be described. Reference numerals will be used during the description to indicate parts or portions of the present invention. Throughout these views, like reference characters will be used to designate like and corresponding parts in various views.

In order to keep the descriptions brief, alternative materials are not introduced, nor are alternative fabrication processes described. Anyone skilled in the art would know that steel components could be substituted for aluminum components and even for plastic parts. The descriptions given below describe embodiments that are cost effective at this time and not intended to communicate it will always be preferred. The sizes of the components are provided to clarify understanding and not intended to limit the scope of the invention.

Typically parabolic troughs are installed as a long row when multiple units are used. The system described below is placed with the axis of rotation going north and south. This means that the trough assembly 30 rotates from the east to west during a normal day. The electro-mechanical system used to electrically sense or predict the location of the sun is not described in this patent as these devices are currently available and described on other patents.

In FIG. 1, a trough assembly 30 is shown consisting of a trough body 31 that is about 36 inches wide and 96 inches long in the first embodiment. It is created in a mold with sheets of aluminum about 48 inches wide and 96 inches long although other processes such as extrusion lend themselves to this type of design. The polished aluminum reflector material on the inside of the trough body is available from Alanod (www.alanod-solar.us, phone 208-726-3003) and has been extensively tested by National Renewable Energy Laboratory and rated for 10 years environmental exposure. The material is available in 0.010, 0.020 and 0.030 inch thickness and called “MIRO-sun”. Details regarding creating the trough body will be provided later.

The trough body 31 is supported by a set of circumscribing rings 34. The ring 34 is rolled from 6061-T0 aluminum “C-section” beam about 1″×2″×0.125″ thick and welded to form a circle about 39 inches on the inside diameter. Depending on specific geometry, other heat treats and alloys of aluminum can be used. It is important that the ring 34 be welded in a jig so it remains flat on the face and easily rolls in the spools 40. Excess weld must be removed from the inside of the ring 34 to prevent binding in the spools 40. Other features are welded to the ring 34 to simplify field construction and will be described later in the process.

FIG. 8 shows the trough body 31 rigidly connected to the ring 34 with a set of bent tabs 32, and ⅜″ diameter bolts and nuts 60. FIG. 12 shows more detail on the tab connection. A Lower tab 62 is welded to the ring prior to field assembly and the upper tab 32 is placed over the trough body 31 to connect it to the ring 34. A bolted connection is used so the trough body 31 can easily be replaced if it is damaged. Placement of the lower tab 62 is critical as it controls the height of the parabolic reflective surface from the trough body 31 and thus controls how the reflected light will hit a receiver 52 after passing through a borosilicate glass pipe 50.

The receiver is 0.5 inch diameter steel tubing that is electroplated with black nickel or black chrome. It is covered with a borosilicate glass tube 50 that is 1 inch inside diameter. The receiver tube 52 does not rotate and will be connected to other plumbing to convey a hot fluid such as mineral oil. The receiver tube 52 is supported inside the glass pipe 50 with a PTFE spacer 74 shown on FIG. 11. There is a loose fit between these components to allow for thermal expansion and contraction, as well as to allow moisture to vent if it gets trapped in the glass pipe 50. The glass pipe 50 is supported with a standard galvanized steel pipe strap 64 and clamping is done with a small'/inch bolt and nut. To better accommodate thermal expansion effects a ⅛″ thick silicone pad is placed between the pipe strap 64 and the glass pipe 50. This prevents fractured pipe as the temperatures increase and change both the diameter and the length of the glass pipe 50.

Adjustment of the location of the receiver 52 is possible by using the threaded bolt 60 and tightening or loosening until the glass pipe 50 is at the exact center of the ring 34. An upper support 54 made of 1″×⅛″ aluminum angle is welded to the ring 34 early in the process to provide long term support for the receiver and glass tube.

Each ring 34 is nested over two spools 40 machined or injection molded of black polyethylene or cast aluminum. These spools 40 are about 1.7″ wide so they fit between the flanges of the ring 34. The spools have an outside diameter of 2.75 inches and inside hub diameter of 2.25 inches. They are sized to allow contact on two surfaces to minimize stress. One area of contact is between the spool 40 and inside the ring 34 as shown in FIG. 2 and FIG. 3. The second set of contact is between the ring 34 outside flange diameter and a torque tube 34 made of steel or aluminum.

Rotational actuation is transferred with either a thin strap 56 made of stainless steel, nylon or polyester. Currently a small 0.060 inch diameter stainless steel wire rope or cable 58 works well because there is plenty of room left on the spool for rotational tensioning. The spools 40 are fixed to the torque tube 38 by conventional means such as a set screw going through the body of the spool (not shown). They are not welded because one spool is rotated to tighten the cable 58 upon installation.

In order to prevent slippage and assure rotation of ring 34, cable 58 must be rigidly connected to the ring 34 with a U-bolt 59 as shown on FIG. 1. Location of the U-bolt 59 is important. When the trough is inverted for storage, the left spools 40 wind up most of the cable 58, the U-bolt 59 should be mounted about two inches above the spool and bolted through the ring 34 to offer maximum travel before it gets to the opposite spool 40.

For the cable drive to function properly and not slip, each end of the cable 58 terminates in one of the pair of spools 40. FIG. 9 shows a cable slug 66 staked to the end of the cable 58 and fitting into a mating feature of the spool 40. A slug cable termination is well known and a countersunk hole is used in the spool to prevent it from pulling out. FIG. 10 shows another embodiment when a 0.020 inch thick plastic or 0.010 inch thick stainless steel strap 56 is used. A special fitting cap 70 must be used. The strap bolt 68 and cap 70 clamp down on a hole in the strap 56 to firmly hold it in place and provide a round surface for the strap 56 to rotate against.

Spools 40 are mounted to the torque tubes 38 on 96 inch intervals to match ring 34 spacing and trough body 31 length. The spools are anchored with set screws to the torque tube 38. Dog point set screws are preferred as the torque tube can be drilled and offer positive contact and prevent slippage at high torque. Other clamping means are commercially available such as a tapered cone used to hold sheaves to a shaft. The tapered cone attachment method is easier to use when adjusting the cable tension rotationally, but higher in cost than set screws (not shown).

Torque tube 38 is either steel or aluminum material one inch in diameter. Drawn over mandrel (DOM) steel tubing is preferred as it holds tight tolerances for good fits to other components. This tubing must be painted prior to use to prevent rusting. Powder paint has excellent corrosion resistance and is cost effective. The tubes 38 pass through plastic bushings 37 in a base 36 for enhanced wear and lower friction. The bushings can be made of high density polyethylene but must have sufficient clearance for expansion in hot weather and contraction in cold weather. A 0.020″ clearance is suggested between the bushing 37 inside diameter and the torque tube 38 outside diameter.

The base 36 is short as shown in FIG. 1 or FIG. 8 and useful for residential applications that need to be as close as possible to the roof decking. With a short base as shown, the chain 44 would impact the trough body 31 if placed directly under the trough assembly 30. For this reason, the gear-motor 46 is placed outside of the first ring 34 as shown. This prevents an interference condition with the trough body 31. The end of the torque tube 38 is connected to a sprocket 42 with conventional means, typically a set screw (not shown).

The gear-motor 46 provides rotary energy to drive a set of chains 44 that ultimately turn torque tubes 38 and ring 34 attached to trough body 31. The axle of gear-motor 46 is connected to a dual sprocket 48 so that both torque tubes 38 rotate together. Both tubes must rotate as only one tube powers rotation for a given direction. When the gear-motor reverses at the end of the day to store the trough inverted, the opposing spool 40 will wrap cable 58 and rotate the ring 34 in the opposite direction for storage.

The intent of each embodiment is to allow multiple troughs to be powered by a single gear-motor and use a common receiver 52 and common set of torque tubes 38 that rotate all trough bodies 31 connected together in a row. This is the new and novel feature for a trough system. With Circumscribing rings 34, all the trough bodies 31 in a row can move in unison because they are mechanically joined. Torque is applied to just one row at a time. This allows a smaller gear-motor 46 to be used to drive and brake this set of trough assemblies 30.

No other patents show a device using a flexible member or cable 58 that terminates in two drive spools 40 below the circumscribing ring 34. The new and novel concept has multiple advantages. First, it allows the use of a sandwich type of trough body that is strong enough to sustain all wind loads including the effect of torsion. The second advantage of this concept of using a circumscribing ring allows all trough bodies to be inside the rings 34 and physically connected at their outermost points and thus maximize rigidity and resistance to torque related deformation. This improves the optical efficiency since a rotational error of only 3 degrees can drop heat collection efficiency to zero. The last advantage of this system is that is a fixed focal point design where the receiver never moves. This minimizes maintenance costs from flex hose issues. Because the troughs are physically connected in a row, and the receiver tube never moves, there will never be fractured receivers from a non-synchronous actuator.

Lower tabs 62 and upper tabs 32 are at least one inch wider than ring 34. This allows room for the connection bolts 60 to be placed outside of the ring 34 and thus not impacting spools 40. Wide tabs 62 provide room for the next trough to be butted alongside the first trough of the row. Connection from one trough body 31 to the next trough body 31 at the widest point is strategic. Torque related forces are minimized as the distance is increased. Connecting the trough bodies together on the outside edge minimizes the transfer forces going from one trough body 31 through the upper tab 32, lower tab 62 and into the next trough. In addition, torque tubes 38 work to apply torque uniformly down the entire row of troughs to minimize rotational tracking error from mechanical causes. This concept is novel in application and improves system efficiency by improving torsion stiffness of the structure at the minimum cost.

### Creating Trough Body

Trough bodies 31 are created with a molding process. Past research initially rejected the aluminum and foam sandwich structure based on relative motion of the structure due to stress relaxation at elevated temperatures. In order to eliminate stress relaxation, the process is improved. Internal stresses on the aluminum and in the foam are minimized. The aluminum stress is reduces or eliminated by rolling the aluminum sheet to a shape that closely matches the final parabolic shape. Current troughs built with thin aluminum reflectors do not roll the aluminum and as a result it always has internal residual stresses that fight the parabolic shape. By rolling the aluminum, these stresses are minimizes so the parabolic shape is retained over time and temperature.

The shape of a parabola can be very closely approximated with two radii blended together. The small radii will be directly under the focal point and the larger radii extends to the edge of the parabola. For a given parabola, CAD geometry can be used to determine two radii. Normally a parabola is drawn using the formula x̂2=4 p y or y=x̂2/4p. The value P is the distance from the focal point to the bottom of the parabola. A parabolic shape that is optimized for wind loads will have an equal distance P from the focal point to the highest edge of the trough.

To better understand the advantage of this design, when a trough is created with the focal point centered between the highest and lowest point, and when the trough also rotates around this focal point, wind loading is equally distributed above and below the center of rotation. This minimizes the torque placed on the structure from wind loads and is a novel feature to minimize deformation and improve system efficiency.

When determining the best radii to bend the aluminum sheet, the parabola is drawn based upon material width available. In the first embodiment, 48 inch widths of mirror aluminum sheet are available from Alanod and one inch flanges will be bent one the long edges of the sheet so only 46 inches of material is available for the parabola. Calculus formulas have been employed for a formula x=L/2.542 to calculate the half width of the ideal trough with a focal point as described. In this case a 46 inch surface would have a maximum x value of 18.08 inches for a total width of 36.16 inches. Calculus formulas have been derived to simplify the focal height as P=x/2.828 or in this case P=18.08/2.828=6.393 inches. The total trough depth is 2P or 12.786 inches deep and the focus is half way down the trough.

Finally, after this parabola described above is drawn, a small radii is overlaid over the parabola. The parabola is broken into 3 sections, the center of which is the smallest radii. Width of the parabola is 36.16 inches as discussed above. The small radii is drawn with tangent points at 12.08 inches width (from x=−6.40 to +6.04) in the center portion. It will be found that a 14.7 inch radius will closely match the parabolic shape in this central third zone. The outer radii is then drawn from this tangent point where x=6.04 to the outside edge where x=18.08. When the two curves are tangent, the resulting second radii is 29.38 inches.

A novel roller table assembly 200 has been developed as shown in FIG. 6 and FIG. 18. Other roller devices could be used, but this one is very low in cost to build. This device can be used to on a variety of thin metal sheets depending upon their length. On this example, the roller table is 10 feet 6 inches wide to roll up to 10 feet long sheet stock. Operation of the roller table assembly 200 is as follows.

Aluminum sheet 200g has flanges bent on the edges as shown in a standard sheet metal brake. These flanges are used to help form the trough edge in later steps. The aluminum sheet 200g s loaded into a lower table 200d with the top table in a vertical position. The aluminum sheet 200g is held in position with clamps 200i, then rotated through pivot pin 200c to a horizontal position. The top table 200a rests on the front vertical support 200b. The aluminum sheet 200g is now held between top table 200a and lower table 200d with the lower edge constrained by bent stop 2003 and wood spacer 200f. The spacer is needed to allow the bent flange on the sheet to drop below and under the lower table 200d on some parts. Now the lower table is pushed and pulled along the rails 200h to put a permanent bend along the sheet metal. The sheet metal is bent like this in two operations. The sheet is bent for the large second radii first, then only the center section is rolled for the second radii. When complete, the sheet has an almost perfect parabolic shape that matches the mold tooling.

The sheet metal has “spring-back” and must be rolled tighter than the final radii in order for it to stay at the final desired radii. Testing has been completed on 0.020 inch thick Alanod aluminum MIRO sun reflector and 0.032 inch thick 3003 H14 aluminum sheet. The data on this chart shown in FIG. 26 was documented by rolling actual sample sheets of aluminum and documenting the results. Different material will have different results, but this is provided to clarify the method for a good parabolic shape in the sheet metal. The chart shows what forming radius to use to get a held radius on the sheet metal. The equations at the top can be used to calculate the forming radius to set up the roller table. The top table 200a and lower slide 200d form a diameter and the distance is set by moving the pivot pins 200c so the distance between the top table 200a and lower slide 200d is the forming diameter.

For the first example, the large held radii on 0.020 Alanod is 29.5 inches, and the curve interpolated to use a 5.5 inch forming radii or 11 inch diameter on the roller table 200. Later, the inside held radii needs to be 14.7 inches so the forming radii is 3.88 inches with a roller table diameter of 7.76 inches. The same procedure is used to set up and roll the outside sheet of the trough body although the dimension of the radii will be increased by the target thickness of the final trough body. In this case, with a foam core thickness of 1.5 inches thick, the inner held radii would be 14.7+1.5=16.2 inches. This would need a forming radii of 4.6 inches or 9.2 inch diameter setting on the roller table. Remember to use the formula or curve for the 0.032 inch thick backing aluminum sheet as shown on FIG. 26.

The urethane foam process also minimizes the stress in the mold by keeping the mold pressure as low and as uniform as possible. Low mold pressure is accomplished through trial and error in order that just enough mixed resin is added to fill the mold. When the mold is overfilled, it develops very high internal pressures and this deforms the mold. The target internal pressure is one to five pounds per square inch per polyurethane resin supplier North Carolina Foam Industries. The foam used on these examples was described as a pour foam at 2 pounds per cubic feet target density. In order to have very repeatable parts, both the resin temperature and the mold temperature must be maintained. The resin is held at 80 degrees Fahrenheit and the mold is held at 100 degrees Fahrenheit in these examples.

The amount of resin can be initially estimated by taking the part volume times the density for a final weight of foam. Normally 10% is added to the weight to accommodate waste material that stays in the mixing container. The foam is blend of two chemicals, polyol and isocyanurate in this example although other blends and chemicals are available. In this case, the part is 46 inches in surface length and 1.5 inches thick and 96 inches long for a total volume of 6624 cubic inches or 6624/1728=3.83 cubic feet of expanded foam. The weight of the part would be 3.83 cubic feet×2 pounds per cubic feet=7.66 pounds and require 10% more material as an estimate for the mold or 7.66×1.1=8.43 lb. Using instructions from the resin supplier, the volume of resin is calculated by Weight/Density=Volume or 8.43 pounds/10 pounds per gallon=0.843 gallons total of liquid. This material is a 50-50 mix by volume so needs 0.422 gallons of each resin. The polyol would weigh 0.422 gallons×10.1 pounds per gallon=4.26 pounds and the isocyanurate would weigh 0.422 gallons×9.9 pounds per gallon=4.18 pounds. Each liquid is weighed out as a liquid, and then thoroughly mixed and immediately poured between the sheets of aluminum in the open mold. It rapidly expands to fill the volume in the molded cavity and make a trough body. One example of a mold is shown in FIG. 21. This particular mold shape is for the second embodiment which is a large two piece trough with symmetric trough bodies. The mold has a top cavity 202a. the is lowered over the bottom cavity 202c or they can be connected with a hinge joint. The left side 202e and right side 202b are used to provide the proper part thickness and keep the foam in the proper shape geometry at the edges. Bolts 202d are used to fasten mold sides to the top cavity 202a and bottom cavities 202c. External heaters or built in heat rods can be used to keep the mold at temperature. An electronic control is suggested to automatically keep the mold at proper temperature.

Prior to rolling the sheet metal the inside surfaces must be hand cleaned with alcohol or acetone for an excellent bond to the urethane foam. The thin film of oil on the aluminum sheet will affect the bond and result in a very weak part. In short, each sheet of aluminum is bent and rolled for this embodiment. The edge connections are shown in FIG. 22, with a “Z-strip” 100b. The bent flange of the bottom sheet 100z fits into one gap of the Zstrip 100b. The bent flange of the aluminum reflector 100c fits into the other gap of the Zstrip 100b. This type of connection works well to keep urethane foam trapped behind the aluminum and it also takes up tolerance conditions so the aluminum sheets can move and fully comply with the mold shape. The foam cures at least 45 minutes and the part can be removed. The ends of the trough must be coated with epoxy paint for protection from sun and water. Ultraviolet light will slowly degrade the strength of the urethane foam so the exposed foam is painted. In addition, if water can penetrate the cells of the foam, it will degrade performance when the water freezes and damages the foam cell structure. Urethane foam of 2.0 pounds per cubic feet minimum is used because it is a closed cell structure that naturally resists water penetration. This same material is used in ocean buoys and proven to survive outdoor conditions.

The aluminum perimeter is inserted into the end of the mold and one end of the mold is bolted closed. The liquid urethane is thoroughly mixed for at least 15 seconds with a paint mixing tool operating at 3600 revolutions per minute. This assures a uniform mix and foam density and prevents localized defects and were detected in early experimentation by other researchers but never resolved.

The new and novel part about this trough is the fact that the process is controlled tightly enough to assure a part with uniform density because of close controls to resin weight, material and mold temperature, mixing and part cleanliness. Once a strong part is formed, it will retain its parabolic shape long term because there is minimal internal stress in the aluminum or in the urethane foam. The long term properties are what set this product aside as different and improved in performance. Prior literature rejected the use of urethane foam, but they did not describe any of the key process controls needed to attain a good part. The article that describes prior testing is Sandwich Construction Solar Structural Facets Jan. 21, 1999, by Richard B Diver and James Grossman of Sandia National Laboratories Albuquerque, N. Mex. 87185.

### OPERATION

### First Embodiment—FIG. 1

Assuming the trough assembly 30 is assembled as described in earlier paragraphs, the left spool 40 is on the east side and fully wound with about 14 turns of cable and with the trough body 31 inverted and connected to the ring 34. As the sun rises, electronic controls are used to turn on a gear-motor with an internal gear ratio of at least 200. The total ratio of the system is calculated as follows. The dual sprocket 48 drive on the gear-motor 46 is about 2 inches and the sprocket 42 on the end of the torque tube 38 is four inches for a ratio of 2.0. The ratio at the ring 34 at 38 inches outside diameter and spool 40 diameter at 2.75 inches is 38/2.75=13.8. The total system ratio is 200×2×13.8=5520 and offers excellent control of rotational angle to track the sun.

As the gear-motor 46 turns, the drive chains 44, turn the sprockets 42, and the torque tube 38 and the spools 40. For one revolution in the motor, 1/5520 revolutions occur in the circumscribing ring 34 which holds the trough body 31. This means a low cost gear-motor 46 with one output pulse per revolution can be used to get 0.06 degrees of output rotation. The back-driving torque is high enough on most gear-motors to be used as the brake device and hold the trough assembly 30 in position as it tracks the sun. If necessary, a brake can be added to the gear-motor 46 for enhanced locking under windy conditions.

The u-bolt 59 connecting the cable 58 to the ring 34 slowly rotates with the ring as the sun traverses the sky during the day. As the day ends, the trough is facing west and the u-bolt 59 is now near the west spool 40. The electronic controls sense the u-bolt 59 with a proximity switch or because of the time of day, the gear-motor 46 reverses direction to move the trough to the inverted initial position.

In this manner, sunlight is continually focused on the receiver tube through the day. At night and in bad weather the troughs are be stored in the inverted condition. Periodically, the reflector surface must be washed with water to reduce losses from dust on the optical surfaces. As the trough is in operation, a high temperature oil, such as mineral oil, is heated in the receiver and circulated to the point of use at temperatures up to 450 Fahrenheit which is the advised maximum temperature for PTFE used as a bushing 74 in the receiver.

### DESCRIPTION

### Alternative Embodiment—FIG. 4 and FIG. 5

An alternative embodiment of a large trough assembly 100 is shown on FIG. 4 and FIG. 5. This embodiment consists of two trough bodies 101 for larger applications. The system is mounted on a prefabricated base with posts 118 and a horizontal brace 122 used to support the system. These are then anchored to concrete piers in the ground (not shown). An alternative support method is to use posts 118 anchored in the ground as shown in FIG. 19 using concrete 119. The torque tubes 112 are supports with pillow blocks 108 and restrained in horizontal motion with standard pipe collars 140 held in place with set screws (not shown). All materials of construction in the second embodiment are similar to materials in the first embodiment.

In the field, post holes are dug in a straight line on ten foot centers. Posts 118 are driven slightly in the ground and concrete 119 fills the hole. The posts are then all aligned with a laser to be linear and level. The posts are predrilled with slots to install the pillow blocks and adjust height if needed. After concrete cures, the pillow blocks 108 are mounted with bolts and nuts 60. Large spools 110 about six inches in diameter are mounted to the torque tube 112 and then the tube 112 is installed in the pillow blocks 108. The torque tubes are welded together or joined with a mechanical joint that will not slip. Welds are cleaned and painted for corrosion resistance. The process continues for up to 10 troughs or the midpoint of the row where a gear-motor drive is connected. Total rotational deformation is minimized if the drive is placed in the center of the row.

The gear-motor 114 is mounted to a horizontal brace 122. The gear-motor 122 employs a dual sprocket 48 fixes with set screws (not shown) to the shaft of the gear-motor 122. Large chains 122 are connected to the dual sprocket 48 and the sprockets 120 on the torque tube 112. The chain is tightened by moving the gear-motor down in slots (not shown) machined in the brace 122. The sprockets 120 slide onto the middle torque tube 112 in a row and are connected with dog point set screws (not shown). Once all torque tubes 112 and large spools 110 are assembled the spools are spaced 120 inches apart, a large circumscribing ring 102 can then be placed over the spools 110. The ring is in a position such that the

A slug is attached to one end of a cable 128. The wire rope cable 128 of ⅛ inch diameter and 7×19 stainless steel construction is wrapped 5 turns around the east spool 110, around the ring 102 and the west spool 110. The cable 128 feeds into a counter-bore feature of the spool 110 to be anchored. A slug (not shown) is staked to the output end of the cable 128 after feeding through the counter-bore of the spool 110. The cable 128 is tensioned by rotating the spool about 10 turns and ending with 50 foot pounds torque. The spool 110 is attached to the torque tube 112 by drilling and installing set screws (not shown) through the spool 110 and torque tube 112.

The I-beam subassembly 106 is connected to the ring 102 in a vertical orientation. With a bolt passing through the bottom of the I beam assembly 106 and a bracket welded to the ring 102 as shown in FIG. 15. The I beam is 120 inches long and made of aluminum channel three inches tall by 2.5 inches wide and having a 0.25 inch thick wall. A trough body 101 is aligned with the I-beam and the bottom end is placed into the appropriate cavity of the I-beam 106h. Jigs (not shown) may be used used to hold I-beam assembly 106 in position until the trough bodies 101 are installed. A second body 101 is aligned and installed in similar fashion.

FIG. 7 shows the I-beam assembly 106 has 2 inch by 0.125 inch angle iron features welded to the main I-beam 106h. A vertical support 106a used to support two inch diameter borosilicate glass tube 104. The first and last trough of a row will use an I-beam assembly as shown in FIG. 7. These have two vertical supports 106a and 106g and two lower supports 106c and 106f and two angle braces 106d and 106e. FIG. 13 shows the side view of an I-beam assembly 106 used in concurrent troughs. Vertical support 106g and lower brace 106f and lower angle 106e can be eliminated. FIG. 15 and FIG. 16 shows the vertical support 106a with is a strap support 138 that can slide up or down to best position the receiver 136 to the center of the ring 102. It is held in place by bolt and nut 60. FIG. 17 shows additional adjustment sideways is available when another bolt and nut 60 connecting to the pipe strap 132 is slid to location along a slot in the strap support 138. A PTFE spacer 134 is used to support the receiver tube 136 relative to the glass pipe 104. Clearance of at least 0.030 inches is suggested for thermal expansion and to allow ventilation for moisture to exit. The PTFE spacer 134 is adhered to the receiver tube on ten foot centers with a high temperature silicone adhesive rated to 600 degree Fahrenheit working temperatures.

The ring 102 was fabricated by rolling 3 inch by 1.75 inch by 0.25 inch thick C-channel Aluminum 6061-T0 in a three point roller to an inside diameter of 79 inches. It is cut to length and welded to form a perfect circle. The weld is cleaned from the inside channel to prevent interference with the mating spool. Large lower tabs 124 are welded to the ring 102 in a fixture which assures proper placement of the trough 101 so the focal point is also at the center of the ring 102. The large tab is 0.25 inches thick by 6 inches wide to allow plenty of contact area for the trough and allow bolt connection at the top. As an option, a parabolic strap (not shown) 0.125″ thick by 3 inches wide can be welded to the lower tab for enhanced strength.

After the trough bodies are installed in the I-beam assembly 106, the glass pipe 104 is placed into the pipe clamps 132 and clamped in place with ¼″ bolt and nut 72. To better accommodate thermal expansion effects a ⅛″ thick silicone pad is placed between the pipe clamp 132 and the glass pipe 104. This prevents fractured pipe as the temperatures increase and change both the diameter and the length of the glass pipe 104.

### OPERATION

### Alternative Embodiment—FIG. 14

Assuming the trough assembly 100 is assembled as described in earlier paragraphs, the left spool 110 is on the east side and fully wound with about 14 turns of cable and with the trough body 101 inverted and connected to the ring 102. As the sun rises, electronic controls are used to turn on a gear-motor 114 with an internal gear ratio of at least 200. The total ratio of the system is calculated as follows. The dual sprocket 48 drive on the gear-motor 114 is about 2 inches and the sprocket 120 on the end of the torque tube 112 is four inches for a ratio of 2.0. The ratio at the ring 102 at 82.5 inches outside diameter and spool 110 diameter at 6 inches is 82.5/6=13.7. The total system ratio is 200×2×13.7=5500 and offers excellent control of rotational angle to track the sun.

FIG. 4 and FIG. 5 show that as the gear-motor 114 turns, the drive chains 116, turn the sprockets 120, and the torque tube 112 and the spools 110. For one revolution in the motor, 1/5500 revolutions occur in the circumscribing ring 102 which holds the trough body 101. This means a low cost gear-motor 114 with one output pulse per revolution can be used to get 0.06 degrees of output rotation. The back-driving torque is high enough on most gear-motors to be used as the brake device and hold the trough assembly 100 in position as it tracks the sun. If necessary, a brake can be added to the gear-motor 114 for enhanced locking under windy conditions.

The u-bolt 130 connecting the ⅛ inch stainless steel cable 130 to the ring 102 slowly rotates with the ring as the sun traverses the sky during the day. As the day ends, the trough is facing west and the u-bolt 130 is now near the west spool 110. The electronic controls sense the u-bolt 130 with a proximity switch (not shown) or because of the time of day, the gear-motor 114 reverses direction to move the trough 101 to the inverted initial position of 15 degrees from straight down. The slight angle is intended to provide better stability in extremely high winds of 120 miles per hour by induces a small amount of turbulence under the trough.

As the electron controls cause the motor to turn and track the sun, sunlight is continually focused on the receiver tube 136 through the day. At night and in bad weather the troughs are be stored in the inverted condition. Periodically, the reflector surface must be washed with water to reduce losses from dust on the optical surfaces. As the trough 100 is in operation, high temperature oil, such as mineral oil, is heated in the receiver 135 and circulated to the point of use at temperatures up to 450 Fahrenheit which is the advised maximum temperature for PTFE used as a bushing 134 in the receiver 135.

### CONCLUSION

### Ramifications, and Scope

Accordingly the reader will see that according to one embodiment of the invention, I have provided a low cost parabolic trough that accurately tracks the sun for optimum efficiency. The drive system is unique in that it uses circumscribing rings to hold all the troughs of a row together. Since the troughs are connected on the outside edges, one to the next continuously, this maximizes their ability to hold torque with minimum deformation. This is in contrast to most other trough systems that have support posts between each trough and use an actuator to rotate each individual trough. A side benefit of the continuous row of troughs is the fact that they all rotate together Conventional troughs have high maintenance cost as the receiver tube and glass fracture when individual troughs are not synchronized or when they deform excessively under torque loads.

The disclosed ring and spool system has a final gear ration of about 5000 (including the gear-motor) and this allows precise tracking of the sun to 0.06 degrees per revolution of the drive motor. The gear-motor is a significant cost saving compared to expensive hydraulic actuators used in conventional systems. The high back-driving torque of the gear-motor is used as a brake to hold the trough assembly in position and maximize the amount of heat collected in windy conditions. Each trough has a cable encircling the ring to both rotate it to track the sun and to restrain it under high wind conditions. Since there are support posts on each side of the trough and spaced every ten feet, the system can survive 120 mile per hour wind loads with easy to install posts rather than using massive concrete piers like conventional systems.

The continuous row of troughs is possible because of the unique sandwich type of trough construction with a foam core and aluminum skin. The costs are minimized by making the inner reflective surface also become part of the structure. The trough body will sustain loads equivalent to 120 mile per hour wind gusts with this new fabrication method. The assembly process disclosed is very important in order to create a reflective surface which maintains the parabolic geometry over time and temperature. This is accomplished by minimizing the internal stress from the aluminum sheet and from the urethane foam. Stress in the aluminum is minimized by rolling the sheet to a parabolic shape rather than using a flat sheet of material like conventional troughs. Stress in the foam is minimized by injecting the right weight of foam resin into the mold to minimize mold pressure caused by overfilling. In addition, the foam resin and the mold are held at constant temperature for predictable expansion of the foam. Foam uniformity is assured by high speed mixing for at least 15 seconds prior to pouring it into the cavity.

This embodiment has the receiver tube at the center of focus and the center of rotation so it does not need to move. As a result, flex tubes are not required at the end of each row. This results in lower initial and lower maintenance cost. The parabolic shape is purposefully designed to minimize rotational torque in wind loads. This is done by placing the focal point of the parabola half way down into the trough cavity. Since the center of focus is also the center of rotation, the wind loads tend to balance out.

While the above description contains much specificity, these should not be construed as limitations on the scope of any embodiment, but as exemplifications of the presently preferred embodiments thereof. Many other ramifications and variations are possible within the teachings of the various embodiments. For example, as already described one embodiment is with a single trough body and a second embodiment is larger with two symmetric trough bodies. The same method could be used with three or four special shaped trough bodies for an industrial sized trough. The polyurethane foam could be replaced with poly-isocyanurate foam. The troughs could be build without aluminum Z-strips on the edges and instead allow exposed foam and then cover it with an epoxy.

Thus the scope of the invention should be determined by the appended claims and their legal equivalents and not by the examples given.

I claim:

1. An angular control mechanism comprising:
a. An angular control ring to provide precise angular positioning under high torque loads. Said ring having a means of direct connection to a flexible member such as wire rope thus providing output rotation without slippage.
b. A quantity of two smaller spools in contact with said ring.
i. Said spools provide a connection means to said flexible member (such as countersunk hole for wire rope slug).
ii. Said spools are mechanically connected to a drive means
iii. Said spools rotate through a center pivot.
iv. Said spools are located approximately 90 degrees apart relative to said ring diameter.
c. A flexible member such as wire rope that can handle the full torque load.
i. Each end of flexible member has a termination to mate with said spool such that the flexible member will not slip when the spool is rotated.
ii. Flexible member is wrapped around said spools such that one wraps while the other concurrently unwraps.
iii. Flexible member is wrapped around said ring and two said spools and provides rotation of said ring in an opposite direction of spools and at a slower speed.
d. A drive means providing torque to the two spools concurrently in the same rotational direction. The drive means typically includes
i. an energy conversion device (such as a gear-motor),
ii. a means to divide torque from said energy conversion device to two spools (such as chains and sprockets),
iii. a means to provide torque to each spool (such as the torque tube)

2. A solar energy concentrator comprising:
a. A trough body formed of the following parts:
i. A sheet of polished aluminum alloy that is at least 0.010 inches thick that forms the reflector and inner skin of the trough.
ii. A sheet of aluminum that is at least 0.009 inch thick that forms the outside skin of the trough.
iii. An internal core made of closed cell thermo-set foam (typically polyurethane) having a minimum tensile strength of 20 pounds per square foot that is adhered to said inner aluminum skin and said outer aluminum skin of trough.
b. Said trough has an internal parabolic shape such that light striking it will be reflected and focus on a common axis.
c. Said parabolic shape of trough has a focal point also designed to be the center of rotation.

3. A parabolic trough system consisting of the following items:
a. An angular control mechanism as described in claim #1 except with multiple angular control rings to form a row of one or more troughs with one common drive means.
b. One or more solar energy concentrators as described in claim #2 assembled end to end to form a single row of troughs
c. Said solar energy concentrator is connected to said rotational drive such that the center of focus is also the center of rotation.
d. A support means for said angular control mechanism such as posts with pillow blocks provided for each trough assembly

4. The device as claimed in 3, wherein said aluminum sheets have minimal residual stress as evidenced by the aluminum sheet naturally conforms to the shape of the foam core with only the force of gravity assisting. This is typically evidence pre-rolling the sheet to prevent future shape changes in the parabola due to stress relaxation.

5. The device as claimed in 3, but including an I-beam assembly to allow two symmetric trough bodies to be mounted to a common ring and make a larger concentrator device.
